(19) United States
(12) Patent Application Publication
(10) Pub. No.: US 2025/0054472 A1
(43) Pub. Date: Feb. 13, 2025

(54) FRAMEWORK AND METHOD FOR MELODY GENERATION

(71) Applicant: Duke University, Durham, NC (US)

(72) Inventors: Stephen Hahn, Durham, NC (US); Cynthia Rudin, Durham, NC (US); Yue Jiang, Durham, NC (US); Simon Mak, Durham, NC (US); Jerry Yin, Durham, NC (US); Rico Zhu, Durham, NC (US)

(21) Appl. No.: 18/791,078

(22) Filed: Jul. 31, 2024

Related U.S. Application Data
(60) Provisional application No. 63/530,277, filed on Aug. 2, 2023.

(51) Int. Cl. G10H 1/00; G06N 3/047; G06N 3/084

(52) U.S. Cl. CPC G10H 1/0025; G06N 3/047; G06N 3/084; G10H 2210/111; G10H 2210/145; G10H 2210/576; G10H 2220/116; G10H 2250/015

(57) ABSTRACT

Methods and system for music generation. One method comprises defining a phrase structure and a metrical layout, and generating a melody based on the phrase structure and the metrical layout using a probabilistic model of contour-sequences in a machine learning model. The probabilistic model includes a plurality of production rules determined by the machine learning model trained on a dataset of hierarchical analyses, and the contour-sequences defining directional patterns between musical notes extracted from the dataset of hierarchical analyses.

### RELATED APPLICATION

The present disclosure claims priority to U.S. Patent Application No. 63/530,277, filed on Aug. 2, 2023, the disclosure of which is herein incorporated by reference in its entirety.

### FIELD

Examples described herein generally relate to music generation using machine learning. In particular, examples described herein provide an interpretable and flexible model for generating music with coherent long-term structure by incorporating musical theories into probabilistic models. The probabilistic models utilize hierarchical structural levels of music (e.g., structured based on Schenkerian analysis) to generate music.

### SUMMARY

Algorithmic music generation (AMG) is becoming increasingly important in art and entertainment. For instance, many video games take advantage of AMG to further engross the player in the game's environment. AMG has also been used to enhance visual art and narratives. Experienced composers use AMG as a tool for inspiration, collaboration and education. Meaningfully, AMG can empower those who have little or no musical background with the ability to engage in the creative process.

However, recent AMG models are difficult or impossible to interpret and manipulate because the vast majority of such models use deep neural networks with thousands of parameters, even for potentially simple tasks. There have been attempts to disentangle deep neural networks using an interpretable latent space. However, it is still practically impossible to understand how the models move from their latent spaces to their generated products. Interpretability is thus an important aspect of the design of human interaction involved machine learning systems for scientific and engineering advancements.

To address these and other challenges, aspects described herein provide methods and systems for performing algorithmic music creation that use machine learning models incorporating musical domain knowledge. These systems and methods outperform existing deep learning approaches with the added benefits of interpretability and flexibility without comprising qualities of the generated music. An additional benefit of this approach is that it requires much less data than deep learning, which relies on vast amounts of training data that is generally not readily available without intensive data cleaning and processing. Thus, the model provided according to examples described herein is less complex than other deep learning models, which allows the model to be customized to particular needs and targets of a requested task. Accordingly, in some examples, given sufficient domain knowledge to set user-defined parameters, the model can produce reasonably convincing music with little training data.

For example, one difficult problem in AMG is modeling long-term structure. Examples described herein address this difficult problem by incorporating music theories. For example, two branches of music theory coexist to describe long-term structure in Western classical music: (1) form theory, which describes music's structure in terms of section repetition and variation, and (2) Schenkerian analysis, which aims to understand music's hierarchical harmonic-melodic structure. By involving and adapting one or both of these music-theoretical concepts of form and harmonic-melodic structure, the model provided according to examples described herein produces convincing melodies with structural coherence.

Some examples described herein provide a model using a grammatical approach, incorporating music-theoretical domain knowledge, that is adjustable (e.g., based on user-input) to generate unique, personal results, even by users with little to no musical background. In particular, some examples described here provide a model defining a probabilistic context-free grammar (PCFG) for contours between notes at varying levels of structure. The model also incorporates Markovian structures for deeper levels of structure and harmony.

For example, aspects described herein provide a method for music generation comprising defining a phrase structure and a metrical layout, and generating, with at least one electronic processor, a melody based on the phrase structure and the metrical layout using a probabilistic model of contour-sequences in a machine learning model, the probabilistic model including a plurality of production rules determined by the machine learning model trained on a dataset of hierarchical analyses, and the contour-sequences defining directional patterns between musical notes extracted from the dataset of hierarchical analyses.

For example, aspects described herein provide an apparatus comprising at least one processor, at least one memory storing instructions executable by the at least one processor; and a machine learning model comprising a melody generator, wherein the melody generator comprises parameters stored in the at least one memory and is trained to generate a melody based on a phrase structure and a metrical layout using a probabilistic model of contour-sequences, the probabilistic model including a plurality of production rules determined by the machine learning model trained on a dataset of hierarchical analyses, and the contour-sequences defining directional patterns between musical notes extracted from the dataset of hierarchical analyses.

For example, aspects described herein provide a method for training a music generation model, comprising defining a phrase structure and a metrical layout, obtaining training data including a ground-truth middleground harmonic sequence and a ground-truth foreground melody based on a dataset of hierarchical analyses, generating a melody based on the phrase structure and the metrical layout using a probabilistic model of contour-sequences in a machine learning model, the probabilistic model including a plurality of production rules and the contour-sequences defining directional patterns between musical notes extracted from the dataset of hierarchical analyses, computing a melody loss based on a difference between the generated melody and the ground-truth foreground melody, and updating parameters of the machine learning model based on the melody loss.

### BRIEF DESCRIPTION OF THE DRAWINGS

FIG. 1 illustrates an example music generation system.

FIG. 2 illustrates an example model used by the music generation system of FIG. 1.

FIG. 3A illustrates an example form and Schenkerian analysis of a musical composition.

FIG. 3B illustrates background, middleground, and foreground contours for a portion of the musical composition of FIG. 3A.

FIG. 4 illustrates an example determination of melodic notes based on the contour, harmony, and smoothness measure.

FIG. 5 illustrates an example of pairwise preferences used in model comparisons.

FIG. 6 illustrates example test results of models.

FIG. 7 illustrates an example website architecture of a music generation application.

FIGS. 8A-8E illustrate example screenshots of user interactions within the music generation application of FIG. 7.

FIG. 9 illustrates example tools for generating sentiment-informed sequences.

FIG. 10 illustrates an example key-chord hidden Markov visualization.

FIG. 11 illustrates an example text-based representation of an Schenkerian analysis and a corresponding graphical representation.

FIG. 12 illustrates an example visualization of an Schenkerian analysis as a series of clustering matrices.

FIG. 13 illustrates an example hierarchical music generation process.

FIG. 14 illustrates an example music generation apparatus for performing the hierarchical music generation process of FIG. 13.

FIG. 15 is a flow chart illustrating the hierarchical music generation process of FIG. 13, as performed the computing system of FIG. 14.

FIG. 16 is a flow chart illustrating an example training process for a hierarchical music generation model.

### DETAILED DESCRIPTION

One or more examples are described and illustrated in the following description and accompanying drawings. These examples are not limited to the specific details provided herein and may be modified in various ways. Furthermore, other examples may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some aspects described herein may include one or more electronic processors configured to perform the described functionality by executing instructions stored in non-transitory, computer-readable medium. Similarly, aspects described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As noted above, one challenge in music generation for both humans and computers is to construct pieces with cohesive long-term structure. Some approaches use deep learning architectures such as the transformer neural network. These approaches use transformers to produce expressive piano performances note by note. Besides these transformer-based models, recurrent neural networks (RNNs) such as long-short-term-memory (LSTM) networks were used for sequential tasks. For example, some approaches generate music using a combination of both transformers and LSTMs for melody generation, with a hierarchical music representation used to generate pieces with coherent structures. Alternatively, some approaches generate melodies using a deep hierarchical variational autoencoder (VAE). Recently, the popular transformer-based language model, ChatGPT, has shown to be capable of writing music with limited success. However, ChatGPT is still not capable of generating music near the level of other models. While nonparametric black box methods, specifically deep learning approaches have had some successes, they also have key limitations, both in the ability to capture long-term musical structure and to incorporate user feedback.

To address these and other challenges, approaches described herein provides simpler, easier-to-use modeling techniques that can achieve similar or better performance than these models and approaches described above. For example, approaches described herein use Markovian models in semantic models, such as models are generally simple and transparent. Approaches described herein also use probabilistic context-free grammars (PCFGs), which are sometimes used for music analysis and synthesis. Approaches described herein also incorporate Schenkerian analysis in such PCFGs to utilize deeper levels of musical structure (e.g., hierarchical levels) to provide deeper cohesion.

Schenkerian analysis looks at the hierarchical relationships between tones and harmonies, showing various layers of musical structure. Although many genres of Western music can be characterized using Schenkerian analysis, approaches described herein use such analysis for both music analysis and generation. For example, aspects described herein provide an approach that incorporates Schenkerian analysis into PCFG-based approaches using PCFG models. By incorporating Schenkerian analysis, aspects described herein provide a generative machine learning model that can capture long-term structure of musical composition without using complex deep learning architectures. Specifically, aspects described herein provides a computer system that incorporate form analysis, Schenkerian analysis, and PCFG.

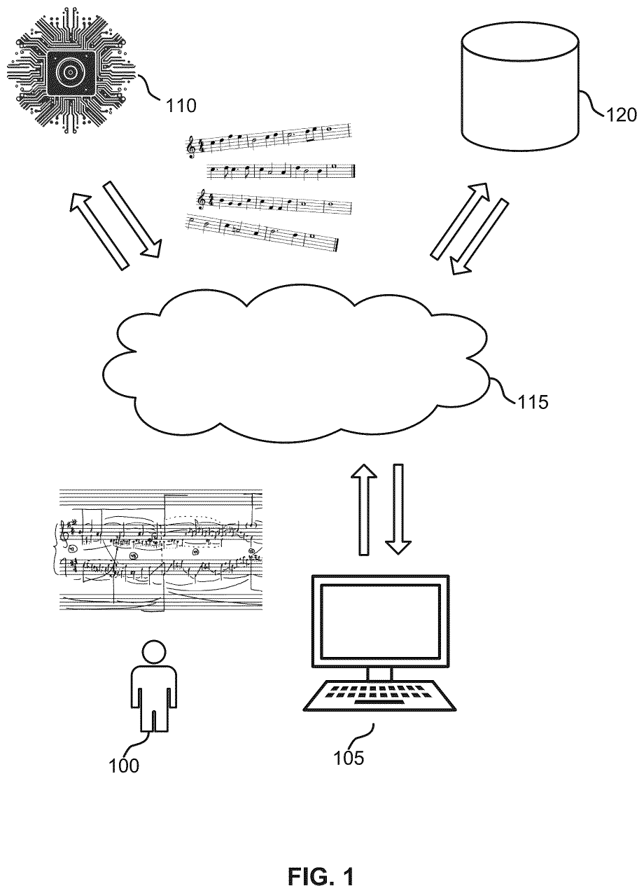

FIG. 1 illustrates an example music generation system. The example system includes user 100, user device 105, music generation apparatus 110, cloud 115, and database 120.

In the example shown in FIG. 1, the user provides input parameters for music generation to the music generation apparatus 110, e.g., via user device 105 and cloud 115. Music generation apparatus 110 then processes these parameters. The apparatus may employ multiple components trained on a dataset of hierarchical analyses, such as Schenkerian analyses, to generate hierarchical aspects of the musical composition, including phrase structure, rhythmic framework, harmonic sequences, and melodies. Hierarchical analysis is an approach that examines musical compositions by breaking the musical compositions down into multiple levels of structure, for example, from the overall form to individual notes. Schenkerian analysis is a type of hierarchical analysis.

In this example, this process may involve multiple stages of generation, each corresponding to a different structural level of the music as informed by the Schenkerian dataset. This multiple-stage process is designed to be both controllable and interpretable, allowing for user intervention and adjustment at various levels of the music generation process. The music generation apparatus 110 generates a musical composition that represents the user's input parameters while reflecting the hierarchical structures found in the Schenkerian analyses. The music generation apparatus 110 is thus able to transform textual descriptions or parameter sets into fully realized musical content grounded in music theory. The output musical composition is then returned to user 100 via cloud 115 and user device 105.

User device 105 may be a personal computer, laptop computer, mainframe computer, palmtop computer, personal assistant, mobile device, or any other suitable processing apparatus. A user interface may enable user 100 to interact with user device 105. In some aspects, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser.

Music generation apparatus 110 may include a processor unit, a memory unit, an I/O module, and a training component. The training component is used to train a machine learning model. Additionally, music generation apparatus 110 can communicate with database 120 via cloud 115.

In some cases, music generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various aspects, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location. It should be understood that, in some examples, the cloud 115 is not used as the music generation apparatus 110 may communicate with the user device 105 directly (over one or more wired or wireless connections) or may be implemented locally on the user device 105.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction. The database 120 may store training data used by the music generation apparatus 110, such as music samples and associated Schenkerian analyses. Music generated by the music generation apparatus (e.g., notes, sheet music, audio files) and/or associated user-defined parameters for such generation may also be stored in the database 120. It should be understood that, in some examples, the database 120 includes non-transitory computer-readable storage medium for storing data used and/or generated by the music generation apparatus 110 and, thus, may represent remote storage (without or without standard database functionality). Also, in some embodiments, data storage may be provided as part of the music generation apparatus 110, such that the separate data 120 (data storage) is not necessary.

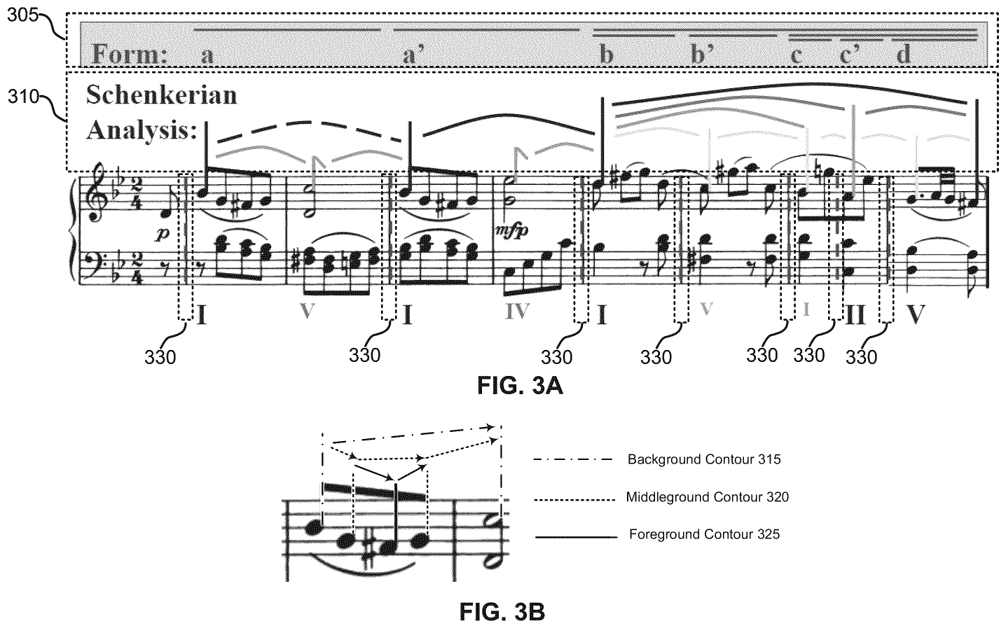

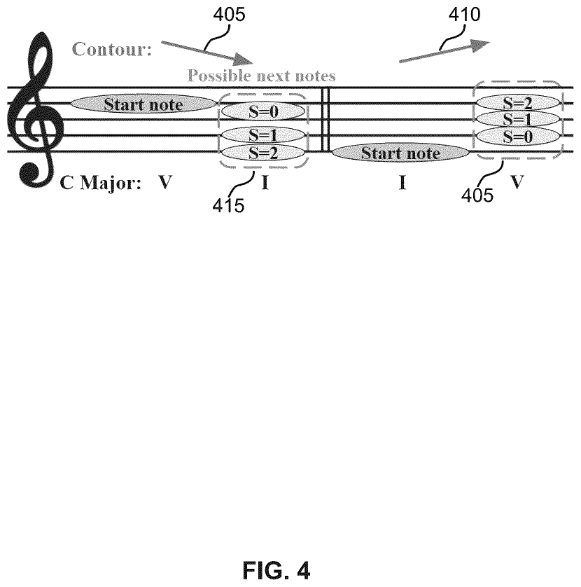

Form analysis is a field of study that breaks a musical piece into constituent sections based on similarities in rhythm, melody, and harmony. For example, sections are broken into phrases, and the phrases can be broken further into subphrases (or motifs). Sections, phrases, and subphrases may be labelled using lowercase and uppercase letters, where relatively larger structures use uppercase letters. In FIG. 3A, subphrase structure of a single phrase in a Beethoven piano sonata is shown as subphrase structure 330, based on related rhythms and melodic contours. Subphrase structure 330 may be determined based on related rhythms and melodic contours. In one example, subphrase structure 330 may be analyzed using form analysis 305. In this example, under form analysis 305, subphrase a is repeated with variation a′ (2 measures each), followed by b and b′ (1 measure each), and c and c′ (half a measure each). Subphrase d (1 measure) ends the phrase.

Phrase structures in Western classical music include the sentence and the period, both used in experiments according to aspects of the present disclosure described herein. For example, the simplest implementation of a sentence may take the form of a-a′-b, where the proportional length of each subphrase is 1:1:2 and b ends with a cadence, is often divided into a sentence structure itself. FIG. 3A may thus be viewed as an example of a sentence within a sentence within a sentence. A period consists of two phrases, an antecedent (A) and a consequent (B or A′), each ending with a cadence, where the first cadence is “weaker” than the second. Cadences ending on an “open” harmony such as V are considered weakest, while “closed” cadences such as those ending on I are stronger. Phrases that make up a period may be sentences themselves or made of less organized subphrases.

Schenkerian analysis aims to capture the hierarchical harmonic-melodic structure of a piece of music. From a Schenkerian perspective, a piece of music as written in the score is the musical foreground. Non-harmonic tones such as passing, neighboring, and anticipating tones may be pruned from the foreground to find the next level of structure. This process may be repeated until the background structure (the Ursatz or “fundamental structure”) is revealed. The upper voice's background structure is known as the Urlinie or “fundamental line.” Any and all levels of structure between the foreground and background are said to be part of the middleground structure. In Schenkerian terms, the background is said to be deeper than the foreground, with levels of the middle-ground distinguished by their relative depths.

An important concept in Schenkerian analysis is that of prolongation. A note is prolonged when the note governs a section of music at a certain level of depth, even if it is not actually present at all times. An example is shown in structure 310 in FIG. 3A. Structure 310 includes prolonged notes in Schenkerian analysis. In this example, in the G minor melody, D-C-B♭-A-G-F♯, the notes C (m. 6), B♭(m. 7), A (m. 7), and G (m. 8) may be understood as structurally subsidiary, prolonging the motion from D (m. 5) to F♯ (m. 8); D is considered structurally in control until the occurrence of F♯. At a shallower depth (towards the foreground), C and B♭ may be understood as prolonging the motion from D to A, and G prolonging the motion from A to F♯. In FIG. 3A, longer stems and bolder lines represent deeper levels of structure. While the bass line is important to the structure, aspects of the present disclosure focus on melody and harmony. In FIG. 3A, the bass annotations are omitted for simplification.

A context-free grammar (CFG) [symbol] is defined by four components: (1) [symbol] , a finite set of variables known as nonterminals, where each nonterminal defines a sub-language of the language defined by [symbol] , (2) Σ, a finite set of terminals, which exist at the foreground of a language, (3) [symbol] , the finite set of production rules, where a nonterminal may produce any number of nonterminals and terminals, and (4) [symbol] , the start variable (in [symbol] ), which represents an entire single realization of the grammar. Probabilistic CFGs (PCFGs) extend CFGs with the addition of [symbol] , a set of probabilities associated with production rules of [symbol] .

Accordingly, aspects described herein provide a generative machine learning model that generates music in a process imitates the process that a human composer might take when composing music using a novel data processing sequence and model. This music generation process may be viewed as a top-down approach, allowing for interpretable music generation. In this top-down process, at the top, the phrase structure is generated independently. For example, the phrase structure is pre-determined during the training process. The phrase structure refers to a series of alphabetic characters that describe a series of subphrases and their relationships. The metrical layout includes a mater and a hyper meter. The meter and the hypermeter determine the lengths of measures and subphrases, respectively. For example, the meter and the hypermeter are pre-determined during the training process.

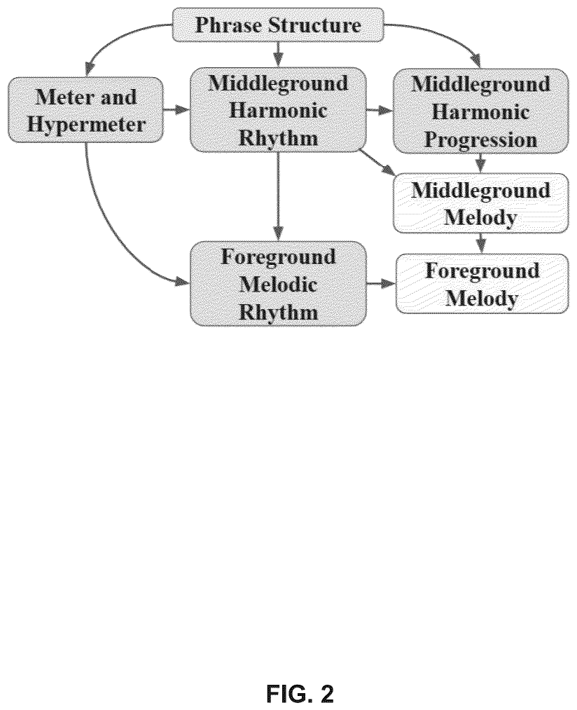

According to some aspects, the model determines the middleground harmonic rhythm based on the phrase structure and metrical layout of the piece, as illustrated in FIG. 2. Harmonic rhythm describes where changes from one harmony to another occur. The particular middleground harmonic progression is then sampled from a Markov chain or PCFG to satisfy the harmonic rhythm. The middleground melody is generated via the novel Schenker-inspired PCFG based on the harmonic progression and rhythm. The model then determines the foreground melodic rhythm. Finally, using the Schenker-inspired PCFG once more, the system generates the foreground melody, completing the generation process.

One aspect provides a method for phrase structure generation. For example, during the phrase structure generation, the model samples phrase structure from common forms found in the literature such as the variations of periods and sentences (e.g., ab, aa′baa″c, abac). Common phrase structures of Western classical music may be used, but the structure is not limited thereto, and can be adapted to fit another musical style. The sampled phrase structures inform the structure of the generated melody. In one example, 12 phrase structures used in a prior dataset of 41 Schenkerian analyses collected from textbooks and music theory faculty are identified. The model may choose phrase structures with possibilities, weighted by how often the phrase structure occur in this repertoire.

One aspect provides a method for rhythm generation. For the rhythm generation, aspects of rhythm including meter and hypermeter, middleground, and foreground are sampled from occurrences in the chosen repertoire, weighted by how often they occur. For example, the meter and the hypermeter are chosen from a small set of possibilities, and portions of middleground and foreground rhythms are sampled and combined to generate a new rhythmic framework.

The rhythm generation process may include a meter and hypermeter generation, a middleground harmonic rhythm generation, and a foreground melodic rhythm generation. During the meter and hypermeter generation, the meter is generated independently as a combination of measure subdivision (duple, triple, quadruple) and beat subdivision (simple, compound) to form time signature

$$\{ ( \begin{matrix}4 \\ 4\end{matrix} , \begin{matrix}3 \\ 4\end{matrix} , \begin{matrix}6 \\ 8\end{matrix} , etc . ) \} .$$

For instance, FIG. 3A is simple duple

$$( \begin{matrix}2 \\ 4\end{matrix} ) .$$

Hypermeter refers to the number of measures for each subphrase or phrase. In Western classical music, sentences (a-a′-b) are commonly composed with subphrases of 2, 2, and 4 measures respectively, such as in the main sentence structure of FIG. 3A. Periods (A-B) are often composed as two 8-measure phrases. The model fits the sampled phrase structure with a proper proportion of measures for each subphrase (1:1:2 for sentences or 1:1 for periods).

During the middleground harmonic rhythm generation, middleground harmonic rhythm is determined based on where middleground harmonic shifts occur. In FIG. 3A, the harmonic rhythm changes at the beginning of every measure except the penultimate one, which also changes halfway through. The model examines each phrase and uniformly samples a common harmonic rhythm based on its length from all possibilities. For example, FIG. 3A shows middleground harmonic shifts occurring at bold vertical boundary lines and large Roman numerals within the musical score. Harmonic rhythm follows the pattern 4-4-5-1-2 beats in the meter of 2/4.

During the foreground melodic rhythm generation, sections determined by the middleground harmonic rhythm are subdivided into sample rhythms from the repertoire. For instance, many samples from the Beethoven example fill the space of a half note using combinations of notes with shorter durations or a half note itself.

One aspect provides a method for harmonic progression generation. After the generation of the middleground harmonic rhythm, the system fills in the particular harmonic progression. This progression may be generated using probabilistic models. In some cases, a Markov chain may be used. In some cases, a PCFG of harmonic entities may be used.

Harmonic entities can consist of any notes specified by the user or gathered from a dataset's harmonies. For instance, Western classical or pop style may sample from pitch class sets represented by Roman numerals:

$$ℋ = \{ I : \{ 0 , 4 , 7 \} , ii : \{ 2 , 5 , 9 \} , … , vii° : \{ 2 , 5 , 11 \} \} .$$

Here, [symbol] is the set of possible harmonies, which are represented as sets of chromatic pitch classes (0=C, 1=C♯/D♭, . . . , 11=B). In one example, the implementation makes use of the RomanNumeral class in the Python package Music21, which can be straightforwardly manipulated to represent any pitch class set.

Harmonic Markov chain may be used. A single-order Markov chain makes a strict assumption that one element depends only on the element that comes immediately before it. That is,

$$P ( {h}_{t} \vert {h}_{t - 1} , {h}_{t - 2} , … , {h}_{0} ) = P ( {h}_{t} \vert {h}_{t - 1} ) ,$$

where h is a particular harmony [symbol] in and at discrete time step t. The Markov chain according to aspects described herein generates harmonies backwards from a goal harmony. This backwards generation produces goal-oriented progressions within the number of allotted harmonic changes. In most Western styles of music, a phrase may begin practically anywhere, but lead towards a limited number of goal harmonies (e.g., I or V).

Harmonic Probabilistic Context-Free Grammar. For the harmonic PCFG, a CFG with nonterminal variables V and terminals Σ may be defined as follows,

$$ν = \{ {f}_{i} : i ∈ {ℕ}_{\geq 2} \} , \sum = ℋ ,$$

where f∈ [symbol] is a functional category expansion of length i. For instance, in Western classical music, the set [symbol] might include tonic (T), predominant (PD), and dominant (D) functional categories. The start variable [symbol] might lead to a string of variables based on the given harmonic rhythm, such as T4-PD2-D2-I, which may then break into the sequence,

$${[ I - IV - V - {I}^{6} ]}_{T} - {[ IV - i {i}^{6} ]}_{PD} - {[ {V}^{8} - {V}^{7} ]}_{D} - I .$$

Accordingly, the PCFG for harmony imposes long-term harmonic structure on the generated music and allows for the flexibility to use numerous styles.

Aspects described herein provide a method for melody generation. During the melody generation, Contour Probabilistic Context Free Grammar (Contour PCFG) may be used. A simple PCFG of contour sequences may be define. Let the set of variables be:

$$ν = {\to }_{i}^{c} , {↗}_{i}^{c} , {↘}_{i}^{c} : i ∈ {ℕ}_{\geq 2} and c ∈ \{ n h t , ∅ \}$$

where each arrow describes the contour (general direction) from one note to another, superscript c indicates whether the contour leads to a non-harmonic tone (NHT), and subscript i indicates the number of contours that are put together to make the larger compound contour. That is, a note's pitch can be the same, higher, or lower in relation to another's, and a particular sequence of contours may lead to a broader contour. The set of terminals is defined as:

$$\sum = \{ {\to }_{1} , {↗}_{1} , {↘}_{1} , {\to }_{1}^{nht} , {↗}_{1}^{nht} , {↘}_{1}^{nht} \} .$$

That is, contours with a subscript of 1 cannot be broken down further into more contours. To demonstrate, FIG. 3B shows three levels of contours from the first two measures of FIG. 3A. The larger contour 315, [symbol] , is comprised of three smaller middle contours 320 that follow the sequence [symbol] . One of the middle contours 320, →, is further broken down into two smaller contours 325 that follow the sequence, [symbol] . In FIG. 3B, larger contour 315 is an example of background contour, middle contours 320 are examples of middleground contours, and smaller contours 325 are example of foreground contours.

In this example, the set of production rules for the excerpt may be:

$$ℛ = \{ {↗}_{4} ⇒ {↘}_{1} {\to }_{2} {↗}_{1} , {\to }_{2} ⇒ {↘}_{1}^{nht} {↗}_{1} \}$$

where terminals are arrows with subscript 1. The start variable in this case is [symbol] = [symbol] ₄. Each production rule is given a probability by the user or based on its frequency in a given dataset. In the example shown in FIG. 3B, each production rule in [symbol] has a probability of 1.

One aspect provides a Schenkerian Analysis dataset. In one example, contour data may be obtained from the Schenker41 dataset, which consists of 41 Schenkerian analyses from textbooks and some music theory professionals. Additional contour data may be obtained from other sources. For each prolongation, contour information and keep track of production frequency to be used in the PCFGs. In this example, the data are centered around Western classical music of the common practice era, which is a style that Schenkerian analysis was designed for. However, aspects of the present disclosure are not limited thereto, and Schenkerian analysis may be applied to other genres of music.

One aspect provides a method for middleground melody generation. Given the harmonic rhythm, the model generates a middleground note at each harmonic change using a PCFG similar to the PCFG described above. One difference is that no terminal may be an NHT. The start variable produces a contour from the first note to the last, representing a pseudo-Schenkerian Urlinie. Once all contours are determined by the PCFG, the notes are filled in to satisfy the harmonies and smoothest voice-leading. Smoothest voice-leading is defined as the smallest intervallic distance between each consecutive note. In other words, the smoothest melody uses the fewest semitones necessary to travel from the first note to the last.

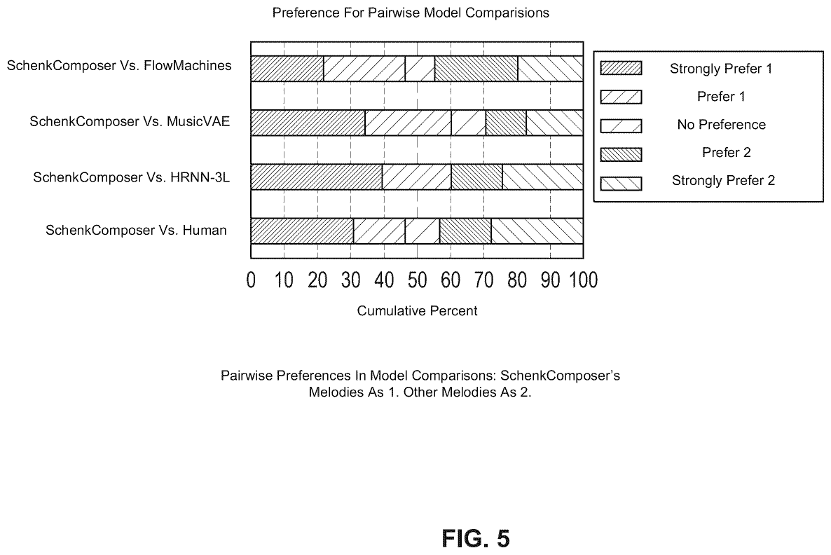

One aspect provides a method for foreground melody generation. Based on components for the melody including harmony, middleground melody, foreground rhythm, and phrase structure, the foreground melody may be generated. The generated foreground melody may give the piece its unique character. Given that the foreground rhythm is obtained, contours derived from the PCFG can be mapped to notes in the melody. Using these contours and a measure for smoothness ( [symbol] ), melody notes can be placed within the harmonic and rhythmic frameworks. In one example, harmonic tones are handled first. If the next note in the melody is native to the harmony and it is set that [symbol] =0, the next note will be set as the nearest harmonic tone in the direction of the contour. Greater values of [symbol] offset the next note as shown in FIG. 4. Higher [symbol] increases the intervallic distance between consecutive notes. On the other hand, if the next note is an NHT, then it is chosen in relation to its two surrounding notes and the prescribed contour from a set of common NHT types,
{N, P, IN, SUS, ANT, RET}
   which stand for neighboring, passing, incomplete neighbor, suspension, anticipation, and retardation respectively.

For example, as illustrated in FIG. 4, melodic notes are determined by the contour, harmony, and smoothness measure. The left half shows a V-I progression moving from D5 with contour 405. The first group of possible next notes 415 show the next possible notes depending on smoothness S. The right half shows a similar action with a rising contour 410 and the second group of possible next notes 420.

Neighbor tones may occur as the result of a→₂ contour. Passing tones occur when notes are a third apart and the contours are a third apart and the contours are [symbol] ₁^{nht} [symbol] ₁ or [symbol] ₁^{nht} [symbol] ₁^{nht} or their inverses. In complete neighbors may occur with any interval and either [symbol] ₁^{nht} [symbol] ₁ or [symbol] ₁^{nht} [symbol] ₁ contours, suspensions with →₁^{nht} [symbol] ₁ contours, anticipations with [symbol] ₁^{nht}→ or [symbol] ₁^{nht}→ contours, and retardations with →₁^{nht} [symbol] contours.

$$ℛ = \{ {↗}_{4} ⇒ {↘}_{1} {\to }_{2} {↗}_{1} , {\to }_{2} ⇒ {↘}_{1}^{nht} {↗}_{1} \}$$

According to some aspects, using contours rather than precise intervals allows the model to be more easily generalized to other styles. However, using contours rather than precise intervals may lose some of the structural benefits of Schenkerian analysis, which prescribes that specific notes and corresponding intervals are considered. When using precise intervals, large amounts of data from a specific genre may be required to generate the foreground melody. Aspects describe herein thus provides a method for generating the foreground of any genre from small amounts of data by using contours.

According to some aspects, the model generates subphrase variations using a randomly sampled variation technique. One such technique involves copying the original subphrase rhythms and contours but altering the harmonies. The melody notes are then regenerated to fit the new harmonies. Another technique follows the same process, but with altered contours instead of harmonies. Alternations may also include aspects such as the final subphrase harmony and contour, the smoothness factor, and foreground rhythm.

In some examples, the music generation model provided by aspects described here may be referred to as “SchenkComposer” and may be implemented via the music generation apparatus 110 through the execution of instructions and models as described herein. According to some aspects, to evaluate the performance of SchenkComposer, a survey experiment that compared the output of the model against other state-of-the-art melody generation models was conducted. A Turing test was also performed to evaluate whether the model's output was convincingly human-like. In one example, surveys were conducted anonymously. In another example, an ablation study was used to determine effects and relative importance of each component of SchenkComposer in successfully generating music.

For example, in a survey, melodies generated by the model according to aspects described herein were compared with human-composed melodies and melodies from three leading melody generation models, HRNN-3L, MusicVAE, and Flow Machines. In this example, over 20 melodies were randomly generated from each model and uniformly sampled to evaluate pairwise comparisons. Each excerpt was either 8 or 16 measures and lasted between 16-34 seconds, giving reviewers enough information to make an informed judgement on the quality of the melody. Excerpts were presented in a randomized order as piano MIDI recordings.

In this example, for each pair of melodies the following questions were asked: 1) On a scale of 0 (not enjoyable) to 10 (very enjoyable), how would you rate melody X? 2) On a scale of 0 (certain it's by a computer) to 10 (certain it's by a human), what is your degree of belief that a human composed melody X? 3) Which melody do you prefer? (a) strongly prefer, (b) prefer 1, (c) no clear preference, (d) prefer 2, (e) strongly prefer 2. 4) Were there any parts of melody X that stood out as sounding weird or bad to you? (yes=1, no=0).

The mean enjoyability for each competing excerpt versus the excerpts generated via the SchenkComposer were compared using a paired t-test. For the Turing test, the survey evaluated the mean confidence that each excerpt was composed by a human compared to the actual human-composed excerpt using a paired t-test. Exact (Clopper-Pearson) binomial confidence intervals were calculated for the proportion of participants that strictly preferred SchenkComposer compared to the competitors. The survey also evaluated whether there was a difference in the proportion of respondents that identified a “weird or bad” sounding excerpt for each competing excerpt versus a SchenkComposer excerpt using a chi-square test.

In one example, eighty people participated in the study; two were removed for claiming to have studied music but providing nonsensical answers for screening questions, resulting in a final analysis dataset of n=78.

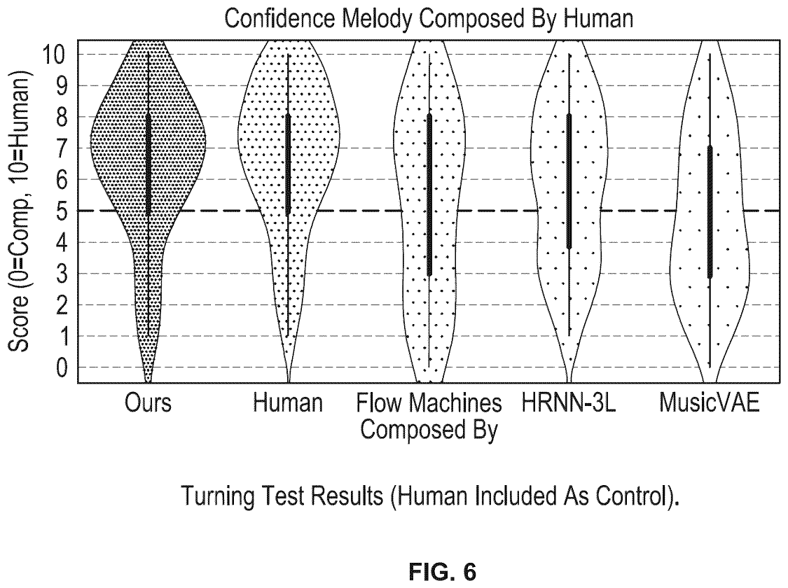

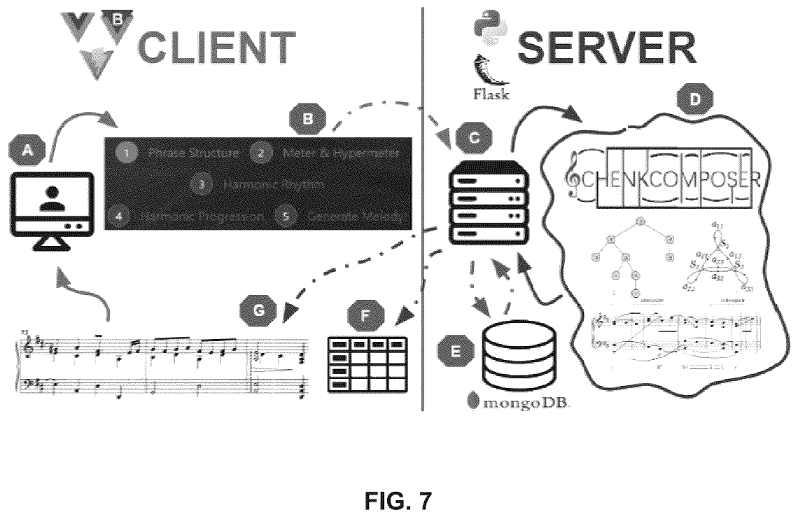

Table 1 demonstrates similar mean enjoyability for SchenkComposer compared to human-composed excerpts. Additionally, sufficient statistical evidence is found, suggesting greater enjoyability scores for excerpts generated using SchenkComposer compared to the current state-of-the-art automated melody generators. Of particular note in FIG. 6 and Table 2 is that SchenkComposer successfully passed the Turing test whereas HRNN-3L, MusicVAE, and Flow Machines did not. FIG. 6 illustrates the Turing test results with a human included as control. This can be seen from the p-values rejecting the hypothesis that the other methods' melodies were composed by a human. FIG. 5 and Table 3 suggest a general preference for the method compared to the current state-of-the-art and demonstrate non-inferiority to human-composed excerpts and Flow Machines. FIG. 5 shows pairwise preferences in model comparisons. SchenkComposer melodies are on the left and other models are on the right. Finally, Table 5 suggests that SchenkComposer generally has significantly lower incidence of “weird or bad” segments compared to the current state-of-the-art.

TABLE 1
Enjoyability (higher is better)

| Method | Mean | 95% CI | p-value |
|---|---|---|---|
| SchenkComposer | 7.11 | (6.85, 7.38) | Ref. |
| Human | 7.29 | (7.04, 7.55) | 0.334 |
| HRNN-3L | 6.23 | (5.63, 6.82) | 0.004 |
| MusicVAE | 5.42 | (4.77, 6.06) | <0.001 |
| FlowMachines | 6.22 | (5.63, 6.82) | 0.008 |

TABLE 2
Confidence of being composed by human

| Method | Mean | 95% CI | p-value |
|---|---|---|---|
| Human | 6.68 | (6.37, 7.00) | Ref. |
| SchenkComposer | 6.45 | (6.14, 6.76) | 0.300 |
| HRNN-3L | 5.80 | (5.20, 6.40) | 0.007 |
| MusicVAE | 4.84 | (4.17, 5.51) | <0.001 |
| FlowMachines | 5.22 | (4.32, 6.13) | <0.001 |

TABLE 3
Proportion of respondents strictly preferring
SchenkComposer (higher is better)

| Method | Proportion | 95% CI |
|---|---|---|
| vs. Human | 0.47 | (0.34, 0.59) |
| vs. HRNN-3L | 0.60 | (0.47, 0.72) |
| vs. MusicVAE | 0.60 | (0.47, 0.72) |
| vs. FlowMacines | 0.47 | (0.33, 0.61) |

TABLE 4
Proportion of excerpts identified as containing “weird
or bad” segments (lower is better)

| Method | Proportion | 95% CI | p-value |
|---|---|---|---|
| SchenkComposer | 0.25 | (0.18, 0.31) | Ref. |
| Human | 0.33 | (0.27, 0.40) | 0.019 |
| HRNN-3L | 0.61 | (0.49, 0.74) | <0.001 |
| MusicVAE | 0.52 | (0.39, 0.64) | <0.001 |
| FlowMachines | 0.27 | (0.13, 0.40) | 0.637 |

Aspects described herein provide a deployment method for the music generation model described above. A web application may be implemented to provide user interaction with SchenkComposer and the melody generation process. The application allows the user to follow the flow of the SchenkComposer model, generating a melody in a top-down style (see FIG. 2).

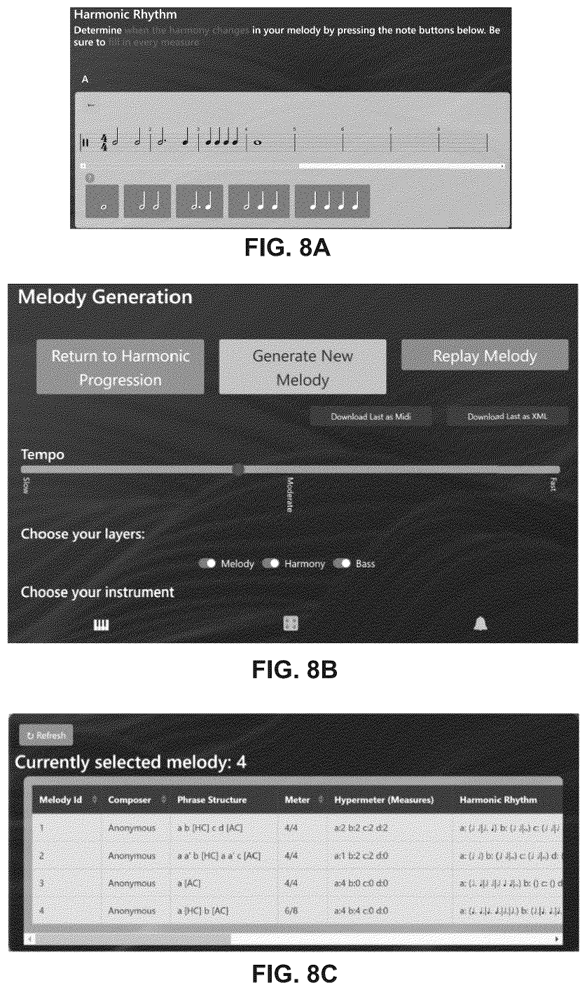

For example, the website allows the user limited manual access to adjust phrase structure, meter, hypermeter, harmonic rhythm, harmonic transition matrix, and harmonic progression. For example, the “deep” structure and flow of the website is depicted in FIG. 7. The website follows a typical client-Server model, where the client interacts with a responsive user interface, and the server processes client requests by communicating with the database as appropriate and the machine learning model (e.g., as implemented via the music generation apparatus 110).

For example, FIG. 7 illustrates architecture of the SchenkComposer website. In FIG. 7, “A” represents a human visiting the public website. “B” is the user interface, which reactively guides the user through the melody generation process. Throughout this process, http requests are sent to “C,” representing the Flask server. “C” processes requests by working with the SchenkComposer model and MongoDB, represented by “D” and “E” respectively. The server (“C”) responds to the client, providing generated melodies and records of saved data (“G” and “F” respectively). The user (“A”) can then process the result of “G” and “F” and update model parameters, repeating the process.

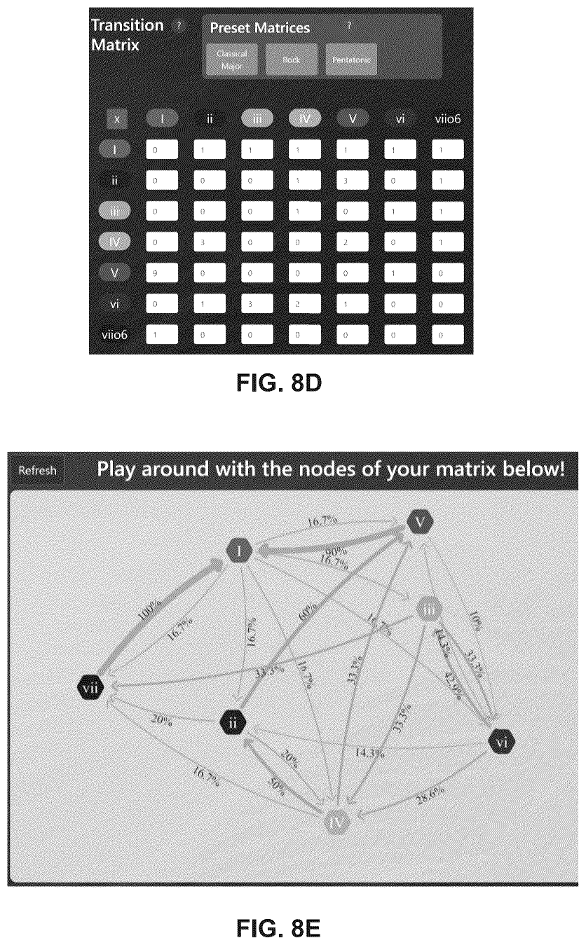

FIG. 8A shows a screenshot of the Middleground Harmonic Rhythm page. Notes are placed in the score (in this example, built with Vexflow) measure by measure by pressing the buttons at the bottom. FIG. 8B shows screenshot of the Melody Generation and playback page. The user can determine their tempo, which layers are playing, and the instrumental ensemble they wish to use. The music is played through the browser using the Tone.js library. The user may also download their melody as a midi file or a musicXML score. FIG. 8C shows screenshot of the transition matrix on the Harmonic Progression Page. The matrix corresponds to the Markov chain shown in FIG. 8D. The user may alter the inputs to the matrix with any non-negative real numbers, directly controlling the way harmonies are produced by SchenkComposer. FIG. 8D shows screen shot of the Markov chain produced from the transition matrix in FIG. 8C. Harmonic labels act as nodes and links between nodes are weighted with probabilities. Nodes may be dragged around, pulling and pushing other nodes using the Graphly D3 physics. FIG. 8E shows screenshot of the user's melodies table. The table displays all parameters and outcomes for each particular melody. Clicking on a row will load a particular melody into the system, allowing parameters to be updated.

The MongoDB database stores melodies and user information, including survey results. Users may create and login to their accounts in order to save and return to melodies and model parameters they produced. Melodies and their parameters are viewable in a table in the user's melodies screen (see FIG. 8E). The website's front-end server is implemented using the Vite, Vue.js, and Bootstrap Vue frameworks along with the Vexflow, Graphly D3, and Tone.js libraries. Vexflow is used throughout the application to generate professional-grade music notation in the browser. Graphly D3 makes it simple to generate the interactive Markov chain found in the Harmonic Progression page (see FIG. 8E). Lastly, Tone.js is used to perform the music from the playback panel (see FIG. 8B). The back-end server, written using the Python Flask framework, handles the log-in procedure, saving and loading information to the MongoDB database, and interaction with the SchenkComposer model. Each step of the melody generation process is explained via an optionally displayed tutorial panel. Music and machine learning concepts are explained and visualized using musical scores and graphs. Tutorial videos and hoverable popup texts may help the user find their way through the website.

Some aspects described herein further provide an interpretable and sentiment-driven model for algorithmic melody harmonization. Sentiment data representation and collection methods are provided. Current representations for musical sentiment are lacking in nuance and diversity. As an alternative to previous models, a simple yet versatile representation for sentiment data is provided. Furthermore, easy-to-use tools for collection and visualization of the new data representation are provided.

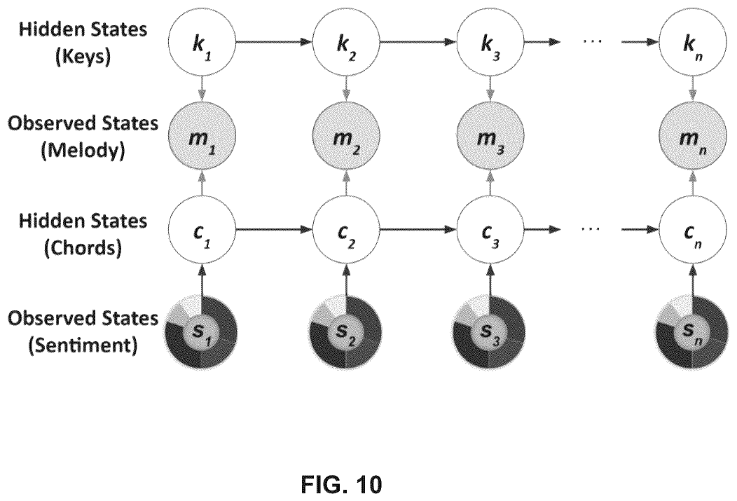

Providing the interpretable and sentiment-driven model involves modeling musical sentiment as a continuous-valued mixture of emotions. For example, instead of categorical descriptors for emotion, the system represents emotion as a continuous-valued mixture (see example in FIG. 10). Using a combination of basic emotions (such as joy, love, sadness, fear and anger), infinite complex emotions may be represented. For instance, to represent “nostalgia,” previous models would have to add a new category. On the other hand, the methods can be used to represent nostalgia as some mixture of joy, love, and sadness. In some examples, the choice of basic emotions used for the harmonization model is based on primary emotions identified by external sources. However, aspects of the present disclosure are not limited thereto, and the methods may use any emotion (and any number of emotions) with this representation.

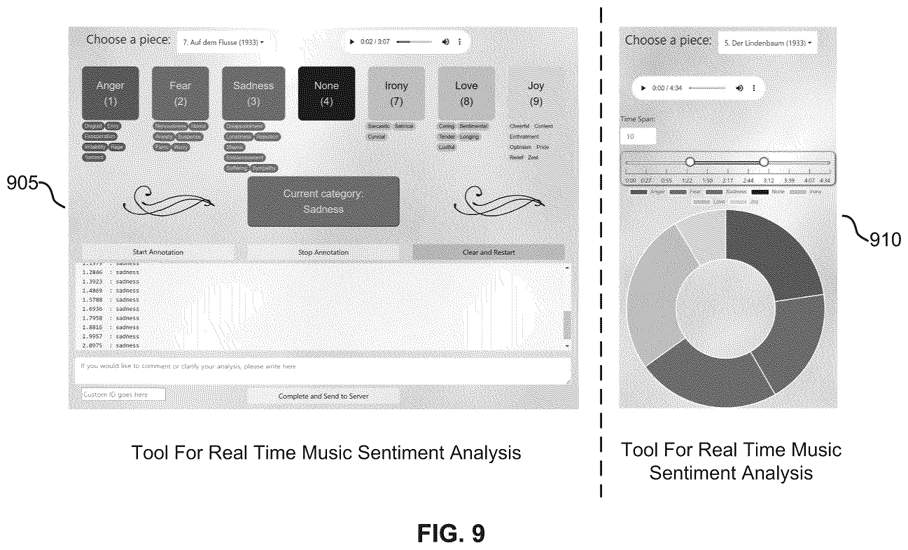

Providing the interpretable and sentiment-driven model involves sentiment data collection. To gather music sentiment data, a web tool (905 in FIG. 9) that records user input in real time (sampling every ˜0.1 seconds, for example) is created. As the user listens to a piece of music, they choose the emotion that best suits the music they hear. The emotion samples from multiple listenings and/or from multiple listeners are combined to create a mixture of emotions for every section of music. A method to visualize the continuous-valued mixture of emotions over a custom range of time is also provided (910 in FIG. 9). In this example, sentiment data is gathered for music that has Roman numeral annotations, so the system is able to determine the probability of each harmony given the concurrent sentiment mixture. In this example, the system determines the exact times that describe a harmony's duration is determined, and then extract the sentiment mixture associated with that time frame.

For the implementation of the interpretable and sentiment-driven model, in one example, the Schubert Winterreise Dataset (SWD) is used. The dataset hosts multiple harmonic analyses, live recordings with annotated timing, and score information for each song in the Schubert song cycle. Note that Schubert's Winterreise, despite its differences with Bach's compositional practice, tends to follow the phrase model like Bach's music and many other styles. Harmonies in the SWD are encoded as a combination of root and quality (major, minor, or diminished), which are easily translated into Roman numeral notation. Using the data collection tool described above, sentiment analysis can be added to the publicly available recordings within the SWD. Chord timings are already provided, so that the corresponding sentiment mixture for each harmony can be determined.

Although data collection tool described above is used for the task of symbolic melody harmonization, it should be emphasized that aspects of the present disclosure are not limited thereto. The data collection tool may be used for a variety of tasks including audio analysis, audio generation, and other symbolic music tasks. The sentiment representation method described above can be used for melody generation.

The interpretable and sentiment-driven model focuses on sentiment-based generation and demonstrates an incorporation of music-theoretic elements. In some examples, the model makes novel use of three elements: key modulation, Roman numeral harmonic notation, and continuous-valued mixture-based affective data. Regarding key modulation, some methods focus only on chord transitions, with chords assumed to belong to only one key throughout the entire piece. However, chord transitions also depend on their location with respect to the whole piece and presence of modulation, and thus existing methods do not capture these musically important nuances, overlooking the prevalence and importance of key modulation. To produce an authentic sounding harmonization, it is crucial to take into account the key transitions in addition to the chord transitions. A chord may refer to a combination of notes played simultaneously. Chords are a component of harmony.

Regarding chord-equivalence representation, many methods treat a concurrent vertical combination of notes as a unique chord. However, functionally identical chords might occur in different forms (e.g., inversions, transpositions). To reduce dimensionality of the emission and transition matrices, these different forms may be treated as one, as in music analysis. In one example, only 35 unique chords are considered in the training dataset and all chorales are transposed to C major or A minor, greatly reducing search space and training time. In this example, the underlying structure (chordal progression and key modulation) rather than absolute pitches of notes is emphasized.

One aspect provides a sentiment-informed Key-Chord Hidden Markov Model. In some examples, the first step in the harmonization framework is to infer plausible key and chordal progressions given an input melody. This may be achieved by a Key-Chord HMM which integrates tonal, chordal, and sentiment structure to achieve efficient, scalable and interpretable harmonization with emotional direction.

For example, let M=(m₁, . . . , mₙ) be the given melody line, with mₜ the melody note at time t (i.e., on the t th beat). This can be seen as a sequence of visible states for the HMM. Let K=(k₁, . . . , kₙ) be the hidden key progression capturing the modulation of the chorale, with kₜ∈K the key at time t, where K is the state space of 24 keys (12 major, 12 minor). Let C=(c₁, . . . , cₙ) be its hidden chordal progression, with cₙ∈C the particular chord at time t, where C is the state space of 35 chords. Finally, let S=(s₁, . . . , sₙ) be the given sequence of sentiment mixtures. The aim is to recover (or decode) the sequences of keys K and chords C from the melody M and corresponding sentiment mixture sequence S.

The Key-Chord HMM can be built in two stages, first for the key progression, then for the chord progression. For the key sequence K, impose the following Markovian model on transition probabilities may be imposed:

$$ℙ ( {k}_{t + 1} \vert {k}_{1} , … , {k}_{t} ) = ℙ ( {k}_{t + 1} \vert {k}_{t} ) = \text{:} {T}_{{k}_{t} , {k}_{t + 1}}^{K} ,$$

for t=1, . . . , n. Here Tₖ_{ₜ}_{,k}_{ₜ₊₁}^{K}=: [symbol] (kₜ₊₁|kₜ) denotes the transition probability from key kₜ to kₜ₊₁, which can be estimated using chorale data. This first-order Markovian assumption is standard for HMMs, and can be justified by the earlier phrase model chordal structure. Given key kₜ, it is assumed that mₜ, the melody note at time t, depends only on kₜ, i.e.:

$$ℙ ( {m}_{t} \vert {k}_{1} , … , {k}_{t} , {m}_{1} , … , {m}_{t - 1} ) = ℙ ( {m}_{t} \vert {k}_{t} ) \text{=:} {E}_{{k}_{t} , {m}_{t}}^{K}$$

for t=1, . . . , n. Here Eₖ_{ₜ}_{,m}_{ₜ}^{K} denotes the emission probability of melody note mₜ from key kₜ. This is again a standard HMM assumption, justifiable by the earlier discussion that the melody line can be well-characterized by its underlying tonality and harmony.

Next, for the chord sequence C, it is presumed that the key sequence has already been decoded from data (call this inferred sequence K*, more on this in the next subsection). The system again adopts a first-order Markovian model for transition probabilities, with an added dependence on the sentiment mixture s at time t:

$$ℙ ( {c}_{t + 1} \vert {c}_{1} , … , {c}_{t} , {s}_{1} , … , {s}_{t} , {s}_{t + 1} ) = ℙ ( {c}_{t + 1} \vert {c}_{t} , {s}_{t + 1} ) = {\sum }_{e = 1}^{E} {ℙ ( {c}_{t + 1} \vert {c}_{t} )}_{e} \cdot {s}_{e , t + 1} \text{=:} {T}_{{c}_{t} , {c}_{t + 1} , {s}_{t + 1}}^{C}$$

for t=1, . . . , n. where e indexes emotions. [symbol] (cₜ₊₁|cₜ)ₑ is the transition probability from cₜ to cₜ₊₁ based on the transition matrix associated with emotion e. Weight s_{e, t+1} represents the proportion of emotion e at time t+1 from the emotion mixture eₜ₊₁.

Here, T_{c}_{ₜ}_{,c}_{ₜ₊₁}_{,s}_{ₜ₊₁}^{C}=: [symbol] (cₜ₊₁|cₜ, sₜ₊₁) denotes the transition probability from chord cₜ to cₜ₊₁ with sentiment mixture sₜ₊₁, which is estimated from data. Specifically, each emotion transition matrix may be gathered, which describes all possible [symbol] (cₜ₊₁|cₜ)ₑ, by parsing all transitions in the data where two consecutive chords have greater than a certain threshold proportion ζ of the particular emotion.

The key and chord transitions can again be inferred by the earlier phrase model described above. Given the inferred key kₜ* and chord cₜ, it is then assumed that the transposed melody note δₜ=mₜ−kₜ* (i.e., modulo key change) follows the model:

$$ℙ ( {δ}_{t} \vert {c}_{1} , … , {c}_{t} , {δ}_{1} , … , {δ}_{t - 1} ) = ℙ ( {δ}_{t} \vert {c}_{t} ) = : {E}_{{c}_{t} , {δ}_{t}}^{C} ,$$

for t=1, . . . , n. This leverages the observation that similar harmonic structures are used over different tonalities. FIG. 10 visualizes the Key-Chord HMM model. In FIG. 10, the observed states are the input soprano melody line and sequence of corresponding sentiment mixtures, and the hidden states are the underlying keys and chords.

In some examples, both the emission probabilities E^{k} and E^{c}, as well as key and chord transition probabilities T^{k} and T^{c}, are estimated from training data. The following hybrid estimation approach is provided. First, to ensure the harmonization does not violate progressions from the phrase model, the probabilities of retrogressive chord transitions (i.e., those violating the phrase model) is set to be near zero. The remaining parameters are then estimated from the training data using maximum likelihood estimation. This ensures the model not only generates musically coherent chordal progressions in line with compositional principles, but also permits us to learn a composer's creative style under such constraints. Accordingly, this model requires substantially fewer parameters than existing HMM harmonization models. For example, some other models require estimation of over 2, 800² transition probabilities while the model provided by aspects described herein requires 35²·nₑ, where nₑ is the number of emotions considered (for example, 5 in this example). This yields a computationally efficient and interpretable harmonization model, competitive with state-of-the-art models in terms of harmonization quality. In this example, the Viterbi decoding algorithm is used. The Viterbi decoding algorithm is a popular dynamic programming method for inferring hidden states in HMMs and is widely used in signal processing, natural language processing, and other fields. Here, a two-step implementation of the Viterbi algorithm allows for efficient inference of the underlying key and chord sequences.

Given melody M, the key inference problem is formulated as

$$K * ∈ arg {max}_{K} ℙ ( K \vert M ) .$$

Here, [symbol] (K|M) is the posterior probability of a certain key sequence K given melody line M under the Key-Chord HMM. This optimization, however, involves | [symbol] |ⁿ variables where n is the length of the melody line, which can be high-dimensional. The Viterbi algorithm provides an efficient way to solve this optimization problem via dynamic programming. In this implementation, the Viterbi decoding function in the Python package “hmmlearn” may be used. Similarly, given melody line M and inferred key sequence K*, the chord Algorithm 1 Key-Chord Viterbi decoding Viterbi decoding for keys:

$$C * ∈ arg {max}_{C} ℙ ( C \vert M - {K}^{*} ) .$$

This can again be efficiently solved via the Viterbi algorithm, with the observed states now taken to be the transposed melody M−K*.

Algorithm 1 outlines this two-stage Viterbi algorithm for inferring the underlying key-chord sequence (K*, C*). Here, Vₓ^{X}(t) represents the most probable state sequence, [symbol] (x₁, . . . , xₜ, m₁, . . . , mₜ), where x represents the last particular chord or key in the set of X in the sequence.

Algorithm 1 Key - Chord Viterbi decoding

```
Viterbi decoding for keys:
○ Set V₀^{K}(0) ← 1, Vₖ^{K}(0) ← 0 for all k ∈ [symbol]  .
○ For t = 0, . . . , n − 1, update for all k ∈ [symbol]
    ${V}_{k}^{K} ( t + 1 ) ← {max}_{i ∈ 𝒦} \{ {V}_{i}^{K} ( t ) {E}_{k , {m}_{t + 1}}^{K} {T}_{i , k}^{K} \} .$
○  $Set {K}^{*} as the key sequence achieving {max}_{i ∈ 𝒦} {V}_{i}^{K} ( n ) .$
Viterbi decoding for sentiment - infused chords:
○ Set V₀^{C} (0) ← 1, V_{c}^{C} (0) ← 0 for all c ∈ C.
○ For t = 0, . . . , n − 1, update for all c ∈ C
    ${V}_{c}^{C} ( t + 1 ) ← {max}_{i ∈ C} \{ {V}_{i}^{C} ( t ) {E}_{c , {m}_{t + 1} - {k}_{t + 1}^{*}}^{C} {T}_{i , c , s}^{C} \} .$
○  $Set {C}^{*} as the chord sequence achieving {max}_{i ∈ C} {V}_{i}^{C} ( n ) .$
```

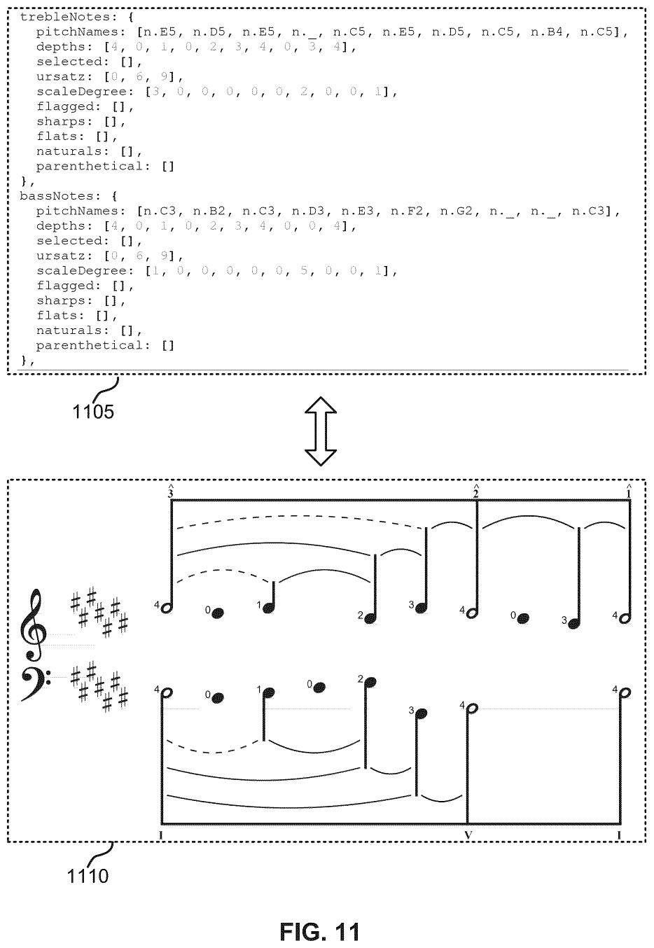

Some aspects described herein further provide a notation method for obtaining a dataset of Schenkerian analysis. A new large-scale dataset of Schenkerian analyses in human- and computer-readable formats. In some aspects, the dataset contains 145 analyses from four analysts for a broad range of composers including J. S. Bach, Mendelssohn, Brahms, Bartok, Shostakovich, Gentle Giant, and more. The dataset is not static and will grow over time. Currently, the vast majority of analyses in the dataset describe the hierarchical relationships within fugue subjects by Bach and Pachelbel. Fugue subjects are ideal for preliminary trials with machine learning models since subjects are generally brief, consist of a single instrumental line (which may consist of multiple theoretical voices), generally have clear functional relationships, and each have a definite sense of closure by their end. Rather than writing out each prolongation explicitly, the system produces prolongations as a by-product when assigning a hierarchical depth to each note. For example, FIG. 11 shows a simplified version of Schenkerian analysis in JSON and graphical as generated by notation software described above. FIG. 11 includes JSON representation 1105 and graphical representation 1110. In FIG. 11, the numbers to the left of the note heads indicate depth. Higher depth indicates deeper structure.

To retrieve the prolongations, the system traverses the graph at each depth level (greater than 0), connecting consecutive notes that are at the same level or higher. Custom prolongations that do not occur within this system may be added in a similar fashion to Kirlin's text format by describing the voice and index of the start, middle, and end notes. According to some simple statistics about the dataset, it can be observed that as depth increases, the distribution of treble intervals moves from smaller to larger intervals, while bass intervals increasingly concentrate around 0 and 5. These statistics suggest that surface level treble motions in the dataset are mostly stepwise and span larger intervals at deeper levels of structure. Furthermore, deep bass structures tend to hold steady and support the upper voice or move along the circle of fifths by jumping 5 or 7 half steps. Table 3b describes various statistics regarding the notes and depths of the dataset. Columns labeled “inclusive” mean that notes of higher depth are included when counting notes of lower depths. For instance, a depth 4 note is counted in the number of depth 0 notes, while the depth 4 note would not count towards the number of depth 5 notes. The “literal” label counts the note depths as they are defined. The final column describes the distribution of max depths over all excerpts.

One aspect provides a data collection tool. To facilitate the collection and visualization of Schenkerian data, a new computer notation system is provided for Schenkerian analyses (see FIG. 11). In some examples, the data collection tool is capable of notating up to four voice structures of any length. Simple commands allow the user to adjust the pitches, note depths, harmonic/scale-degree label, notes considered part of the Ursatz, etc. Slurs and beams of the outer theoretical voices are automatically generated based on the depths of the notes. The data collection tool may also be able to render custom markings, such as voice exchanges, unfoldings, and linear progression beams.

The Schenkerian analysis may be viewed as a simple standardized object in JavaScript Object Notation (JSON), which is generalizable, lightweight, and simple to parse, and is able to capture obscurities within a particular analysis. The JSON object contains metadata about the analysis, key information, and information on each of four theoretical voices. Metadata describes the analyst, composer, title, subtitle, and any associated written description of the analysis. Furthermore, each theoretical voice is encoded as a list of pitch names, depths, Ursatz indices, scale degree/Roman numerals, flagged note indices, sharp/flat/natural indices, and parenthetical indices. Additionally, the JSON object stores “cross voice” symbols such as voice exchange lines and lines indicating related tones across larger spans of time.

Translations between text notations and a JSON notation, for example, between Kirlin's OPC text notation and the JSON notation, may be conducted. To translate from text to JSON, the notes can be parsed from the musicxml and placed in their appropriate voice. Then note depths may be determined by the location and relative length of their prolongation. Translating from JSON to text is straightforward, as one can traverse each depth and retrieve the prolongations.

One aspect provides a method for representing Schenkerian analysis as a heterogeneous graph data structure. As described above, Kirlin's model simplifies the difficult problem of performing Schenkerian analysis, using a limited version of Yust's MOP representation for Schenkerian analysis. With a greater amount of data, less compromising representations may be used for modeling. The following section describes how a musical score may be represented as a heterogeneous-edge directed graph data structure and how Schenkerian analysis may be conceptualized as a graph clustering problem.

For example, music can be represented as a heterogeneous directed graph G, where each node describes a note, and various types of edges describe the relationships between notes. Concretely, G is represented as ( [symbol] , X), where [symbol] ∈{0,1}^{h×n×n} describes the set of h adjacency matrices (one for each edge type) over n nodes, and X∈ [symbol] ^{n×d} is the node feature matrix with d as the number of features. These d features may be learned by a neural network, for instance, to correspond with categorical and numerical musical features.

Some encoding scheme may be used the purpose of Schenkerian analysis. For example, nodes may be encoded with a musical feature present in the score, such as pitch class, octave, absolute duration, position (absolute or relative), metric strength, etc. In one example, five main edge types are used: (i) forward edges connect two consecutive notes within a voice, (ii) onset edges connect notes that begin at the same time, (iii) sustain edges connect notes that are played while the source note is held, 366 (iv) rest edges are like forward edges, but imply a rest occurs between the two related notes, and (v) linear edges connect each note with the next notes that occur at some interval up or down from the source.

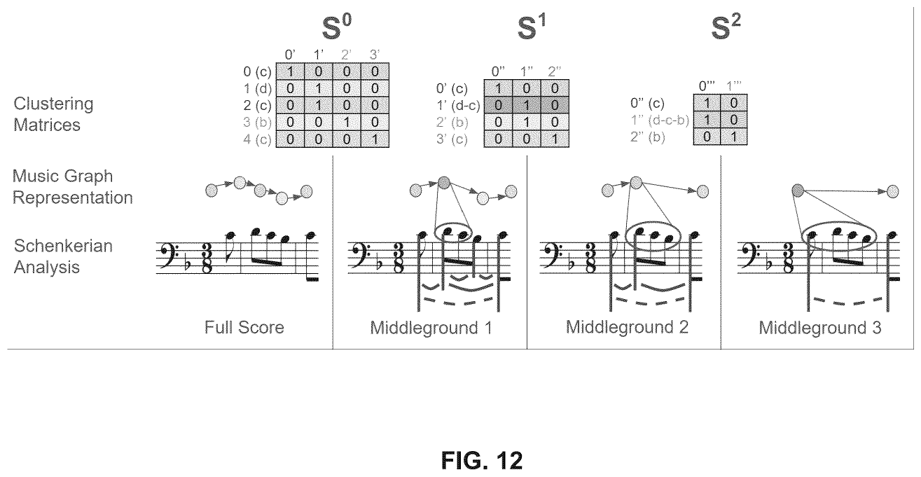

Next, Schenkerian analysis can be conceptualized as a hierarchical clustering problem. The process of Schenkerian analysis may then be posed as a hierarchical graph clustering problem. FIG. 12 illustrates an example of how Schenkerian analysis may be represented as a series of hierarchical clusters. The clustering between two subsequent levels of Schenkerian analysis is expressed through a clustering matrix, S^{(l)}∈ [symbol] ⁿ^{ₗ}^{×n}^{ₗ₊₁}, where nₗ is the number of nodes in clustering layer l and nₗ₊₁<nₗ is the number of nodes after one iteration of clustering, and no is defined to be the total number of notes in the music.

A clustering between any two layers may be represented as a single matrix, denoted as

$${S}^{( {l}_{i} ) \to ( {l}_{j} )} ∈ {{n}_{{l}_{i}} \times {n}_{{l}_{j}}}^{} ; i < j ,$$

where i and j are the index of the source and destination layers respectively. This single matrix is obtained by multiplying all sequential clustering matrices. For example, in FIG. 12, to retrieve the matrix describing how all five nodes of the original score are clustered into the two nodes of the final middleground layer, the system can multiply each clustering matrix together:

$${S}^{( 0 ) \to ( 2 )} = {S}^{( 0 )} \cdot {S}^{( 1 )} \cdot {S}^{( 2 )} = {[ \begin{matrix}1 & 1 & 1 & 0 \\ 0 & 0 & 0 & 1\end{matrix} ]}^{⊤} .$$

Schenkerian analyses can be further converted from JSON to matrix notation. In one example, Schenkerian analysis JSON data (collected using the data selection tool described above) requires extra processing to be represented as hierarchical clusters. An algorithm to convert the JSON data into a series of progressively smaller clustering matrices is provided (see Algorithm 2).

In this example, the system first traverses the outer voices of the JSON file, clustering notes of depth 0 into the closest note of higher depth to the left in the same voice. If that note does not exist, it defaults to the closest note of a higher depth to the right. For inner voices, if they do not describe hierarchical depth (all 0 depth), they are clustered 50%-50% between the nearest bass and soprano below and above or left to right, in that order. If the inner voice has specified depth, it is treated similarly to the outer voices. All depths are then decremented, and the process begins again for the next clustering matrix.

Formulation of Schenkerian analyses as a graph clustering problem facilitates more generalizable analysis. Whereas Kirlin's MOP-based model focuses on a single melody as one theoretical voice, a fuller graph representation allows for greater flexibility via any number of theoretical voices. There are, however, several drawbacks with this new approach. Because the clustering works with the notes of the score, it is unclear how to handle cases where multiple theoretical voices converge on a single note. This issue may also be present when handling inner voices of unspecified depth. In one example algorithm, a method of splitting unspecified inner voices 50%-50% between the outer voices, but other approaches may also be reasonable.

Another advantage that the proposed graph clustering representation has over the MOP representation is its ability to cluster multiple notes into one in a single layer. This is particularly common when there are several repeated notes. In a MOP, repeated notes must be given detailed hierarchy, whereas a human expert would generally think of such repetitions as structurally redundant. There are also instances of prolongations that span more than one child, where having only one child would not properly reflect the music. For instance, if the melody over a C major tonic triad (CEG) quickly plays out the upper tetrachord of the scale, G-A-B-C, then the A and B are structurally equal; they both bridge the gap from G to C. On the other hand, allowing multiple children for every prolongation makes the search space for potential solutions orders of magnitude larger.

As the amount of labeled Schenkerian analyses data grows and computational power improves, there is great potential for learning complex relationships via machine learning that may be unattainable in previous analyses. Deep learning has enjoyed considerable success on analyzing the Bach chorale dataset, thus suggesting that Schenkerian analyses can also be learned for broad datasets from different genres. The proposed dataset, notation software and graph representation provide a promising step towards this goal.

Algorithm 2 JSON to Clusters

```
Definitions
parts ← { sop, alto, ten, bass }
nᵥ ← the number of verticalities v (indexed by i ) in an analysis
pᵢ ← note of part p ϵ parts within vᵢ
dᵢ^{(p)} ← depth of note pᵢ
∀p ϵ parts, len(p) = len(d^{(p)}) = nᵥ.
  Procedure CLUSTER (p, i)
  if ∃j < is. t. dⱼ^{p} > 0 then
j ← argmin|i − j| s.t. j < i and dⱼ^{(p)} > 0
ⱼ
```

| | |
|---|---|
| return {(p, j)} | // Note in the same voice to the left |
| else if ∃j > i s. t. dⱼ^{p} > 0 then | |
| j ← argmin\|i − j\| s. t. j > i and dⱼ^{(p)} > 0 | |
| ⱼ | |
| return {(p, j)} | // Note in the same voice to the right |

```
  else
j₁,j₂ ← argminmin(|i − j₁|, |i − j₂|) s.t. (i − j₁) · (i − j₂) ≤ 0 and dⱼ_{₁}^{(sop)} > 0 and dⱼ_{₁}^{(bass)} > 0
ⱼ_{₁}_{,j}_{₂}
  return {(sop, j₁), (bass, j₂)} // Closest two notes in outer voices in opposite directions to the inner voice note
  end if
```

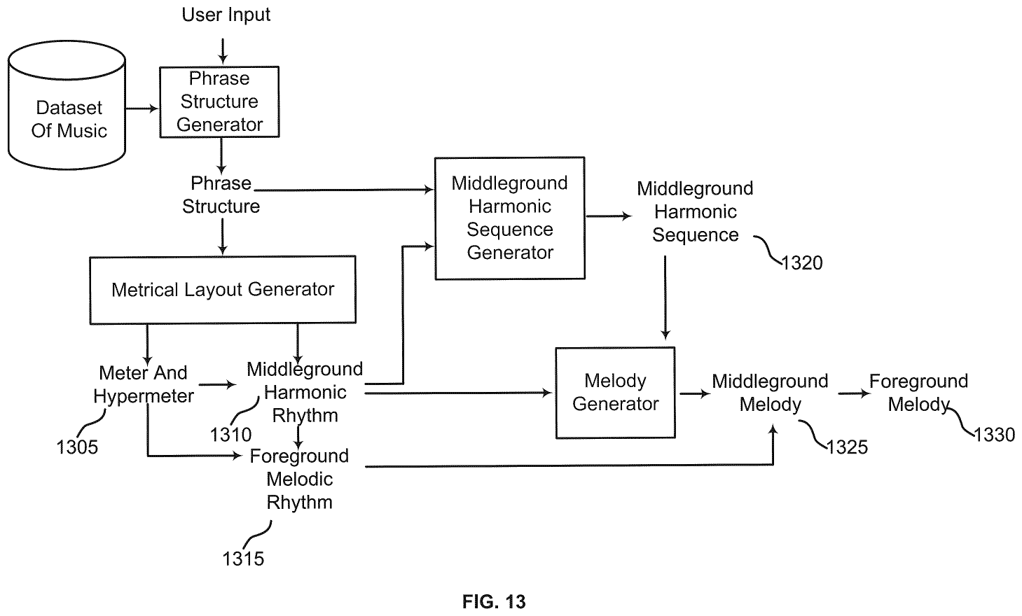

FIG. 13 illustrates a diagram of a hierarchical music generation process. In FIG. 13, the process begins with user input or predefined parameters used as the initial input to the phrase structure generator. The phrase structure generator processes this input by sampling from a plurality of musical forms stored in one or more datasets. The output is a phrase structure. Phrase structure may define the musical composition at a background structural level. For example, the phrase structure represents a simplified, high-level structural representation of the musical form, such as “AABA” or “verse-chorus-verse”.

The phrase structure is then input into the metrical layout generator. This component processes the input to produce three outputs: meter and hypermeter 1305, middleground harmonic rhythm 1310, and foreground melodic rhythm 1315. The meter and hypermeter 1305 define the basic pulse and larger rhythmic groupings. The middleground harmonic rhythm 1310 indicates the composition at the middleground structural level, determining the rate of harmonic change. The foreground melodic rhythm 1315 represents the composition at the foreground structural level, specifying the detailed rhythmic pattern of the melody. For example, the meter and hypermeter 1305 can be a 4/4 meter with a hypermeter of four-bar phrases, indicating a harmonic rhythm changing every two beats, and a syncopated melodic rhythm.

The middleground harmonic sequence generator takes inputs including the phrase structure and the middleground harmonic rhythm 1310. The middleground harmonic sequence generator may be included in a generative machine learning model. The middleground harmonic sequence generator processes phrase structure and the middleground harmonic rhythm 1310 using a harmony probabilistic model, generating the middleground harmonic sequence 1320. The middleground harmonic sequence 1320 indicates the composition at the middleground structural level. For example, the middleground harmonic sequence 1320 represents a detailed harmonic blueprint of the composition, with specific chord progressions aligned to the phrase structure. For example, the middleground harmonic sequence may be a sequence like I-V-vi-IV for each phrase in an “AABA” structure.

Subsequent to the generation of middleground harmonic sequence, the system (the music generation apparatus 110/1440 as described above and below and associated system components) processes the middleground harmonic sequence 1320, the foreground melodic rhythm 1315, and the phrase structure, generating a foreground melody, using the melody generator. In this example, the melody generator may be included in the generative machine learning model. For example, the melody generator uses a contour probabilistic model, generating the middleground melody 1325. The middleground melody 1325 is then further processed to produce the foreground melody 1330. The foreground melody 1330 represents the composition at the foreground structural level, forming the complete musical composition. Accordingly, FIG. 13 illustrates a process of transforming the abstract structural, harmonic, and rhythmic data into a fully realized musical composition according to aspects of the present disclosure.

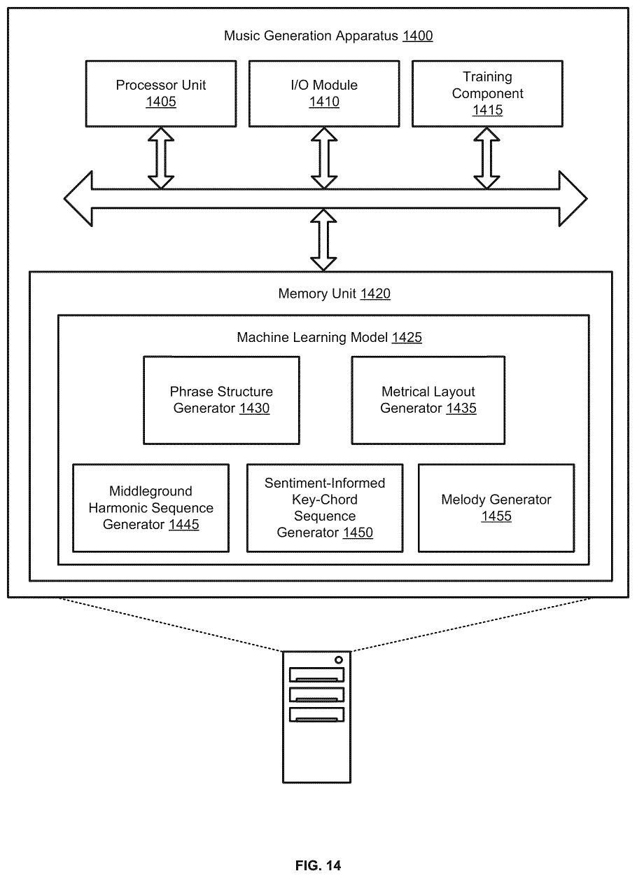

FIG. 14 shows an example of the music generation apparatus 110 (referenced as music generation apparatus 1400 in FIG. 14). The generation apparatus 1400 includes processor unit 1405, I/O module 1410, training component 1415, memory unit 1420, and machine learning model 1425. Machine learning model 1425 includes phase structure generator 1430, metrical layout generator 1435, middleground harmonic sequence generator 1445, sentiment-informed key-chord sequence generator 1450, and melody generator 1455.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1420 to perform various functions. In some aspects, processor unit 1405 includes special purpose components for modem processing, baseband processing, digital signal processing, or transmission processing.

Memory unit 1420 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1420 includes a basic input/output system (BIOS) that controls basic hardware or software operations, such as an interaction with peripheral components or devices. In some cases, memory unit 1420 includes a memory controller that operates memory cells of memory unit 1420. For example, the memory controller may include a row decoder, column decoder, or both. In some cases, memory cells within memory unit 1420 store information in the form of a logical state.

The Input/Output (I/O) module 1410 manages the flow of information between the computer system and external devices or users. For example, the I/O module handles input from devices such as keyboards, mice, or microphones, and manages output to displays, speakers, or other peripherals. In some examples, the I/O module includes a user interface component. For example, the I/O module allows users to input preferences for music generation, such as desired emotional qualities, specific melodic or harmonic features, or structural constraints. Users can modify parameters of the machine learning model through the I/O module. In some examples, the I/O module enables users to input or select phrase structures, influence the metrical layout, therefore modifying the generation process. The I/O module also manages the output of generated music, allowing users to listen to, visualize, or export the composed pieces in various formats.

Training component 1415 is included to enable and facilitate the learning process of the machine learning model 1425. Training component 1415 may use learning algorithms to update the parameters of various generators based on computed losses. For example, training component 1415 calculates differences between generated outputs and ground-truth data derived from hierarchical analyses. Schenkerian analysis is a type of hierarchical analysis, and one example of the hierarchical analysis discussed with reference to FIG. 14 is Schenkerian analysis. The difference may be melody loss and middleground harmony loss. The training component 1415 then uses these losses to adjust the probabilities and parameters of the respective generators, improving their ability to produce musically coherent and stylistically appropriate outputs.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data. Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Phrase structure generator 1430 defines the overall musical form and structure of the composition. For example, phrase structure generator 1430 may determine the arrangement of musical phrases, such as AABA or verse-chorus forms, based on analysis of the Schenkerian dataset or user input. Metrical layout generator 1435 establishes the rhythmic framework of the composition. For example, metrical layout generator 1435 determines the time signature, measures per phrase, and hypermeter of the piece, providing a temporal structure for the subsequent generation processes.

According to some aspects, middleground harmonic sequence generator 1445 is included in the machine learning model 1425. Middleground harmonic sequence generator 1445 creates an intermediate harmonic structure for the composition. For example, middleground harmonic sequence generator 1445 uses a probabilistic model to generate a sequence of chord progressions that align with the phrase structure and provide a harmonic foundation for the melody.

According to some aspects, sentiment-informed key-chord sequence generator 1450 is included in the machine learning model 1425. Sentiment-informed key-chord sequence generator 1450 incorporates emotional content into the harmonic structure. For example, sentiment-informed key-chord sequence generator 1450 utilizes a hidden Markov model trained on sentiment data to generate key and chord sequences that reflect desired emotional qualities, represented as continuous-valued mixtures of basic emotions.

According to some aspects, melody generator 1455 is included in the machine learning model 1425. Melody generator 1455 may create the main melodic line, i.e., the foreground, of the composition. For example, melody generator 1455 uses a probabilistic context-free grammar or Markov model to generate contour-sequences at different structural levels.

In some examples, the melody generator 1455 generate then generate foreground melody based on the middleground harmonic sequence. In some alternative examples, the melody generator 1455 generate foreground melodic notes based on the harmonic context provided by the middleground harmonic sequence and sentiment-informed key-chord sequence.

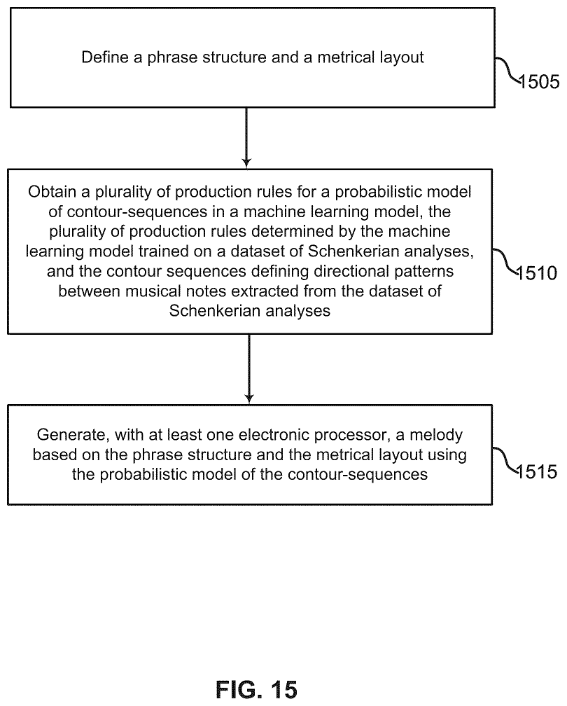

FIG. 15 shows an example of a music generation process. At operation 1505, the system (the music generation apparatus 110/1440 as described above and associated system components) defines a phrase structure and a metrical layout. For example, the system may determine the overall structure of the musical piece, such as the number and arrangement of phrases (e.g., AABA form), and establish the time signature and measure lengths. In some examples, operation 1505 may also involve setting the tempo and determining the hypermeter, which defines a larger-scale rhythmic structure of the piece.

At operation 1510, the system obtains a plurality of production rules for a probabilistic model of contour-sequences in a machine learning model, the plurality of production rules determined by the machine learning model trained on a dataset of hierarchical analyses, such as a dataset of Schenkerian analyses, and the contour sequences defining directional patterns between musical notes extracted from the dataset of hierarchical analyses. One example of the hierarchical analysis discussed with reference to FIG. 15 is Schenkerian analysis.

For example, the system may use a probabilistic context-free grammar (PCFG) or a Markov model to represent the contour-sequences. These production rules may define how melodic contours can be generated at different structural levels such as background, middleground, and foreground. The probabilistic models may include a plurality of rules for generating larger-scale contours (e.g., overall melodic shape for a phrase) and rules for elaborating these into more detailed contours.

In some examples, the contour-sequences are used to represent directional patterns between musical notes extracted from the dataset of hierarchical analyses. The probabilistic models may thus capture patterns of melodic movement. In these examples, compared with the Markov models, the PCFG models may consider both local and broader contexts.

In some examples, during training, the system trains these models on the dataset of hierarchical analyses, learning the probabilities of different contour patterns at each structural level. The system may also incorporate user preferences to modify the parameters of the machine learning model, allowing for customization of the generated music. For example, users may adjust parameters to favor certain types of melodic movement or to emulate specific compositional styles. The system may re-generate a musical composition using the machine learning model with the modified parameters.

In some examples, before generating the melody, the system may generate an intermediate middleground harmonic sequence. The middleground harmonic sequence may be used as a harmonic framework for the melody, providing a coherent harmonic structure at a broader level than individual chords. In some examples, the system may use a similar probabilistic approach to generate the intermediate middleground harmonic sequence. This middleground harmonic sequence helps ensure that the generated melody has a strong harmonic foundation and follows typical harmonic patterns of the chosen musical style.

In some examples, following the middleground harmonic sequence, the system may generate a more detailed foreground harmonic sequence. For example, this foreground harmonic sequence may elaborate on the middleground harmony, providing a moment-to-moment harmonic context for the melody. In some examples, the system may generate the middleground harmonic sequence by adding harmonic entities to the middleground harmonic rhythm using a harmony probabilistic model based on the middleground harmonic rhythm. The middleground harmonic sequence indicates the musical composition at the middleground structural level.

In some alternative examples, the system may further incorporate sentiment data and generate sentiment-informed middleground sequences. The sentiment data may be represented as a continuous-valued combination of basic emotions. The sentiment data may be used to generate key-chord sequences. These sentiment-informed key-chord sequences can then be used alongside the contour-sequences to generate a melody that reflects both musical structure and emotional content.

At operation 1515, the system generates, with at least one electronic processor, a melody based on the phrase structure and the metrical layout using the probabilistic model of the contour-sequences. For example, the system may first generate a middleground harmonic sequence to provide an intermediate harmonic structure for the melody. The system may then use the contour-sequences to determine a set of candidate musical notes, from which it selects the final notes based on a measure of melodic smoothness. As discussed, in the alternative examples, the system may generate a melody that reflects both musical structure and emotional content based on both the middleground harmonic sequence and the sentiment-informed key-chord sequences.

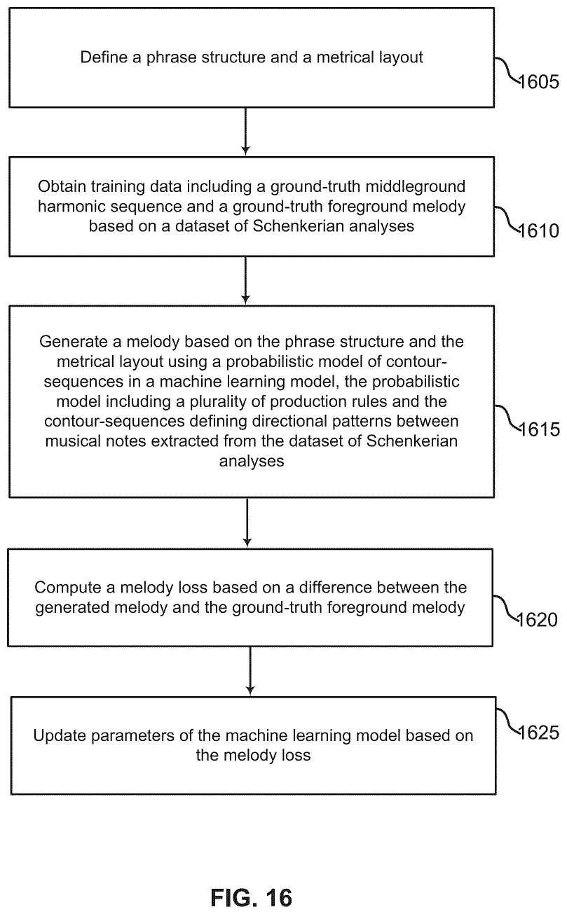

FIG. 16 shows an example of a process for training a music generation model. At operation 1605, the system (the music generation apparatus 110/1440 as described above and associated system components) defines a phrase structure and a metrical layout. For example, this step involves selecting or generating a high-level structure for the music, including the arrangement of phrases and the rhythmic framework. This structure serves as a foundation for both the generation and training processes. The metrical layout may be a rhythm framework including a meter, a hypermeter, a middleground harmonic rhythm, and a foreground melodic rhythm. The metrical layout may be determined based on the phrase structure. The phrase structure and the metrical layout may indicate the musical composition at the middleground structural level and the foreground structural level, respectively. In some examples, the phrase structure and the metrical layout are pre-determined and not updated during the training of the machine learning model.

At operation 1610, the system obtains training data including a ground-truth middleground harmonic sequence and a ground-truth foreground melody based on a dataset of hierarchical analyses. For example, the system processes the dataset of hierarchical analyses to extract hierarchical representations of musical pieces. One example of the hierarchical analysis discussed with reference to FIG. 16 is Schenkerian analysis.

In some alternative examples, the operation 1610 may involve generating a dataset of hierarchical analyses as training data. Generating the dataset of hierarchical analyses may involve generating a directed graph representation of each music score and performing clustering on these graphs to obtain a hierarchical sequence of graph representations. The hierarchical sequence of graph representations may correspond to a sequence of structural levels in music. The system can obtain the ground-truth training data corresponding to a structural level of the sequence of the structural levels based on the hierarchical sequence of graph representations. Accordingly, the system can generate the dataset of hierarchical analyses, thus obtaining the ground-truth data for both middleground harmonic sequences and foreground melodies.

At operation 1615, the system generates a melody based on the phrase structure and the metrical layout using a probabilistic model of contour-sequences in a machine learning model, the probabilistic model including a plurality of production rules and the contour-sequences defining directional patterns between musical notes extracted from the dataset of hierarchical analyses. For example, the system uses parameters of its current model to generate a melody, applying the current or learned production rules to create contour-sequences at different structural levels. In some examples, the system may generate a middleground harmonic sequence using a probabilistic model of harmonic progressions, which provides an intermediate harmonic structure for the melody.

At operation 1620, the system computes a melody loss based on a difference between the generated melody and the ground-truth foreground melody. For example, the system calculates how closely the generated melody matches the ground-truth melody, considering factors including rhythm and contours. In some examples, the system also computes a middleground harmony loss by comparing the generated middleground harmonic sequence with the ground-truth sequence extracted from the hierarchical analyses.

At operation 1625, the system updates parameters of the machine learning model based on the melody loss. For example, the system adjusts the parameters of both the melodic and harmonic models based on their respective loss calculations. This may involve updating the probabilities in the contour-sequence model and the harmonic progression model to improve future generations.

In some examples, the system may incorporate sentiment related information to train the machine learning model. For example, the system may generate sentiment-informed key-chord sequences using a hidden Markov model. In these examples, the training data may include ground-truth sentiment-informed key-chord sequences. The system may compute a sentiment-informed loss by comparing these generated sentiment-informed key-chord sequences to the ground-truth sentiment-informed key-chord sequences. This sentiment-informed loss may be used to update the parameters of the hidden Markov model, improving the music generation model's ability to generate emotionally appropriate and coherent harmonic progressions.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

What is claimed is:

1. A method for music generation comprising:
defining a phrase structure and a metrical layout; and
generating, with at least one electronic processor, a melody based on the phrase structure and the metrical layout using a probabilistic model of contour-sequences in a machine learning model, the probabilistic model including a plurality of production rules determined by the machine learning model trained on a dataset of hierarchical analyses, and the contour-sequences defining directional patterns between musical notes extracted from the dataset of hierarchical analyses.

2. The method of claim 1, further comprising:
receiving user input indicating one or more preferences for the music generation;
modifying parameters of the machine learning model based on the user input; and
generating a modified version of the melody based on the modified parameters.

3. The method of claim 1, wherein generating the melody comprises:
generating a middleground harmonic sequence using the machine learning model, wherein the middleground harmonic sequence defining intermediate harmonic structure of the melody; and
generating the melody based on the middleground harmonic sequence.

4. The method of claim 1, wherein generating the melody comprises:
determining a set of candidate musical notes based on the contour-sequences; and
selecting musical notes from the set of candidate musical notes based on a measure of smoothness of the melody; and
generating the melody based on the selected musical notes.

5. The method of claim 1, wherein the probabilistic model includes a probabilistic context free grammar (PCFG) model.

6. The method of claim 1, wherein the probabilistic model includes a Markov model.

7. The method of claim 1, wherein generating the melody comprises:
obtaining sentiment data by representing musical sentiment as a continuous-valued combination of basic emotions;
generating sentiment-informed key-chord sequences based on the sentiment data by using a hidden Markov model trained on the dataset of Schenkerian analysis and the sentiment data; and
generating the melody based on the sentiment-informed key-chord sequences and the contour-sequences using the hidden Markov model and the probabilistic model of the contour-sequences.

8. The method of claim 1, wherein generating the melody comprises:
generating a directed graph-based representation of musical scores;
generating a matrix representation of the directed graph-based representation; and
obtaining a sequence of structural representations by performing a sequence of clustering operations on the matrix representation, wherein the dataset of hierarchical analyses is obtained based on the sequence of structural representations.

9. An apparatus comprising:
at least one processor;
at least one memory storing instructions executable by the at least one processor; and
a machine learning model comprising a melody generator, wherein the melody generator comprises parameters stored in the at least one memory and is trained to:
generate a melody based on a phrase structure and a metrical layout using a probabilistic model of contour-sequences, the probabilistic model including a plurality of production rules determined by the machine learning model trained on a dataset of hierarchical analyses, and the contour-sequences defining directional patterns between musical notes extracted from the dataset of hierarchical analyses.

10. The apparatus of claim 9, further comprising:
a user interface component configured to receive user input indicating one or more preferences for the music generation and modify parameters of the machine learning model based on the user input, wherein the melody is generated based on the modified parameters.

11. The apparatus of claim 9, wherein the machine learning model further comprises:
a middleground harmonic sequence generator, wherein the middleground harmonic sequence generator are trained to generate an intermediate harmonic structure, wherein the intermediate harmonic structure indicates a simplified version of the melody, and wherein the melody is based on the intermediate harmonic structure.

12. The apparatus of claim 9, wherein the melody generator is further trained to:
determine a set of candidate musical notes based on the contour-sequences, and
select musical notes for the melody from the set of candidate musical notes based on a measure of smoothness of the melody.

13. The apparatus of claim 9, wherein the probabilistic model includes a probabilistic context free grammar (PCFG) model.

14. The apparatus of claim 9, wherein the probabilistic model includes a Markov model.

15. The apparatus of claim 9, wherein the machine learning model further comprises:
a sentiment-informed key-chord sequence generator, wherein the sentiment-informed key-chord sequence generator is trained to:
generate sentiment-informed key-chord sequences using a hidden Markov model trained on the dataset of Schenkerian analysis and sentiment data, the sentiment data representing musical sentiment as a continuous-valued combination of basic emotions, wherein the melody is generated based on the sentiment-informed key-chord sequences and the contour-sequences.

16. The apparatus of claim 9, wherein the dataset of hierarchical analyses is obtained by:
generating a directed graph-based representation of musical scores;
generating a matrix representation of the directed graph-based representation; and
obtaining a sequence of structural representations by performing a sequence of clustering operations on the matrix representation, wherein the dataset of hierarchical analyses is obtained based on the sequence of structural representations.

17. A method for training a music generation model, comprising:
defining a phrase structure and a metrical layout;
obtaining training data including a ground-truth middleground harmonic sequence and a ground-truth foreground melody based on a dataset of hierarchical analyses;
generating a melody based on the phrase structure and the metrical layout using a probabilistic model of contour-sequences in a machine learning model, the probabilistic model including a plurality of production rules and the contour-sequences defining directional patterns between musical notes extracted from the dataset of hierarchical analyses;
computing a melody loss based on a difference between the generated melody and the ground-truth foreground melody; and
updating parameters of the machine learning model based on the melody loss.

18. The method of claim 17, further comprising:
obtaining the training data including a ground-truth middleground harmonic sequence based on the dataset of hierarchical analyses;
generating a middleground harmonic sequence based on a probabilistic model of harmonic sequence, wherein the harmonic sequence defining an intermediate harmonic structure of the melody;
computing a middleground harmony loss based on a difference between the middleground harmonic sequence and the ground-truth middleground harmonic sequence; and
updating parameters of the machine learning model based on the middleground harmony loss.

19. The method of claim 17, further comprising:
obtaining the training data including ground-truth sentiment-informed key-chord sequences;
generating sentiment-informed key-chord sequences based on a dataset of Schenkerian analysis and sentiment data using a hidden Markov model in the machine learning model, the sentiment data representing musical sentiment as a continuous-valued combination of basic emotions;
computing sentiment-informed loss based on a difference between the sentiment-informed key-chord sequences and the ground-truth sentiment-informed key-chord sequences; and
updating parameters of the machine learning model based on the sentiment-informed loss.

20. The method of claim 17, wherein obtaining the training data comprises:
generating a directed graph representation of a music score, performing a clustering on the directed graph representation to obtain a hierarchical sequence of graph representations corresponding to a sequence of structural levels, and obtaining ground-truth training data corresponding to a structural level of the sequence of structural levels based on the hierarchical sequence of graph representations.
